(19) United States
(12) Patent Application Publication
(10) Pub. No.: US 2024/0092122 A1
(43) Pub. Date: Mar. 21, 2024

(54) ADDITIVES IN RUBBER FORMULATIONS

(71) Applicant: BASF SE, Ludwigshafen (DE)

(72) Inventors: Achim Fessenbecker, Ludwigshafen (DE); Ralf Bohlander, Duesseldorf-Holthausen (DE)

(21) Appl. No.: 18/271,881

(22) PCT Filed: Jan. 11, 2022
(86) PCT No.: PCT/EP2022/050398

§ 371 Date: Jul. 12, 2023

(30) Foreign Application Priority Data
Jan. 13, 2021 (EP) 21151313.0

(51) Int. Cl. B60C 1/00; C08K 3/013; C08K 3/04; C08K 3/36; C08K 5/20; C08K 5/54

(52) U.S. Cl. CPC B60C 1/0016; C08K 3/013; C08K 3/04; C08K 3/36; C08K 5/20; C08K 5/54

(57) ABSTRACT

The present invention relates to the use of at least one N,N-dimethylamide as an additive in an elastomeric composition for producing a tread band for vehicle wheels, wherein the N,N-dimethylamide has the formula: formula (I), wherein: R is a C₆-C₁₂ alkyl group, and R′ and R″ are methyl. A further aspect of the present invention concerns a vulcanised elastomeric material for producing a tread band for vehicle wheels obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula (I). An additional aspect of the present invention concerns a tread band for vehicle wheels comprising a vulcanised elastomeric material, which vulcanised elastomeric material is obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula (I). The inventive use and the inventive composition provide effective elastomeric materials particularly suitable for use as treads on vehicle tyres.

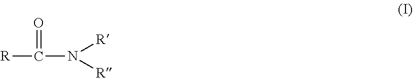

### FIELD OF THE INVENTION

The present invention relates to additives for rubber formulations. The additives may act as a processing aid or as an adjuvant in producing rubber formulations that will achieve good performance characteristics. Such rubber formulations would be suitable in heavy duty applications, such as tyres for heavy load vehicle wheels.

### BACKGROUND OF THE INVENTION

Rubber formulation technology developed over many years to produce rubber for a variety of applications. An important rubber application includes tyres for vehicle wheels. One such example includes silica enforced rubber which is of high interest for the tyre industry. In many tyre applications, for instance, it is desirable to replace at least some of the carbon black by silica. Silica enforced rubbers are known in the art, for instance U.S. Pat. No. 3,867,326, DE 10 2004 005132, WO 2005/056664 and WO 2018/001772.

Documents EP 0763558, US 2004/0220324, US 2007/0293622 and U.S. Pat. No. 6,225,397 address the problems related to elastomeric compositions for tread tires and documents EP 1988120, WO 2006/066602 and EP 1557294 relate to treads for heavy load vehicle wheels.

U.S. Pat. No. 2,325,947 discloses a synthetic rubber prepared by copolymerisation of a butadiene-1,3 hydrocarbon and at least one other unsaturated compound and as a softener a N,N-dialkyl substituted amide of an aliphatic monocarboxylic acid containing from 10 to 20 carbon atoms in a straight chain with each alkyl substituent containing not more than 6 carbon atoms. This reference discloses an example of the softener containing 20 parts by weight of N,N-dimethyl amides of a mixture of single pressed fatty acids containing principally N,N dimethyl stearamide and N,N-dimethyl palmitamide incorporated on a roll bill in 100 parts by weight of a synthetic rubber.

WO 01/88027 describes a vulcanisable elastomeric composition with an intended use as composition for vehicle tyres and specifies one or more of amide compounds having the formula

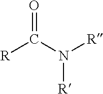

The definition of R includes primary, secondary and tertiary alkyl groups of 1-30 carbon atoms, alkylaryl groups of 5-30 carbon atoms and cycloaliphatic groups of 5-30 carbon atoms. R′ and R″ can the same or different from each other and are selected from the group consisting of hydrogen, C₁ to about C₃₀ aliphatic, and about C₅ to about C₃₀ cycloaliphatic groups. Exemplary amide compounds are said to include erucamide, octadecanamide, ϵ-caprolactam, N,N-diethyldodecanamide.

WO 2010/122396 describes a tyre for heavy load vehicles comprising an insert interposed between a belt structure and a tread band. The insert is located at least at each end of the belt structure. This is made by vulcanising an elastomeric composition comprising a diene rubber and at least one reinforcing filler, in which the reinforcing filler comprises almost exclusively silica. Also disclosed is a tyre containing a vulcanised elastomeric material that is formed from a first elastomeric composition comprising an N-alkyl pyrrolidone derivative.

WO 2012/052328 describes a tyre for vehicle wheels comprising a carcass structure, a tread band disposed in a radially external position to the carcass structure. The tread band is said to comprise a vulcanised elastomeric material obtained by vulcanising an elastomeric composition (a) at least one elastomeric polymer (b) at least one reinforcing filler selected from hydroxides, oxides and hydrated oxides, salts and metal hydrated salts or mixtures (c) at least one N-substituted pyrrolidone derivative, defined therein.

N-octyl pyrrolidone is a commercially available additive used in producing elastomeric materials. However, N-octyl pyrrolidone is a hazardous material.

It would be desirable to provide an additive for rubber formulations that achieves a good combination of processability of the pre-vulcanised elastomeric material properties including hardness, viscosity, elasticity, strength and toughness. It would be desirable to provide such an additive for rubber formulations that at least equals or outperforms existing commercially available and known rubber additives. It would be particularly desirable to provide an additive for rubber formulations that provides similar performance characteristics to commercially available standards, such as N-octyl pyrrolidone, but is less hazardous. It would be more desirable still to provide such an additive which is readily available and/or comparatively easy to obtain.

### SUMMARY OF THE INVENTION

A first aspect of the invention concerns the use of at least one N,N-dimethylamide as an additive in an elastomeric composition for producing a tread band for vehicle wheels, wherein the N,N-dimethylamide has the formula:

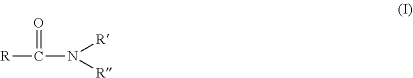

wherein:
R is a C₆-C₁₂ alkyl group, and
R′ and R″ are methyl.

In one desirable embodiment of the use, the elastomeric composition is vulcanised to form an elastomeric material by vulcanising the elastomeric composition which elastomeric composition comprises (a) at least one elastomeric polymer, (b) at least one reinforcing filler selected from hydroxides, oxides and hydrated oxide, salts and hydrated salts of metals or mixtures thereof and (c) the at least one N,N-dimethylamide of formula (I)

A second aspect of the invention concerns a vulcanised elastomeric material for producing a tread band for vehicle wheels obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula (I).

In a further aspect of the invention we provide a tread band for a vehicle wheel comprising a vulcanised elastomeric material, which vulcanised elastomeric material is obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula (I).

### DETAILED DESCRIPTION OF THE INVENTION

The elastomeric materials may be employed in producing a tread band for vehicle wheels. The performance of the elastomeric materials, particularly as all being comprised in tread bands, has been found to be particularly effective.

In particular, the use of the at least one N,N-dimethylamide of formula (I) in the elastomeric composition for making resulting elastomeric materials for tread allows particularly satisfactory results in regard to the tyre characteristics typical for its intended use. For example, it is possible to achieve the required characteristics of abrasion and tear resistance of a tyre for heavy load vehicle wheels, the performance characteristics of low-temperature and on the wet for winter tyres, to achieve a reduced rolling resistance both at low temperatures, (for example 0° C. or lower) and at high temperatures (for example 70° C. or higher) for all seasons vehicle tyres. The inventors believe that the at least one N,N-dialkylamide of formula (I) of the present invention facilitates the dispersibility of filler within the elastomeric material, particularly where the filler comprises silica.

The R group may be a linear, branched or cyclic alkyl group. These alkyl groups may be further substituted, for instance with aryl, arylalkyl, alkylaryl groups or even groups containing heteroatoms, for instance hydroxyl or oxo groups. Nevertheless, it is preferred that the R group does not contain heteroatoms as this may be detrimental to the polarity of the molecules. Preferably the R group is not substituted. More preferably the R group is linear alkyl or branched alkyl and more preferably still linear alkyl.

According to a preferred aspect of the invention, the R of the N,N-dimethylamide of formula (I) is a C₇-C₁₁ alkyl group.

Specific examples of N,N-dimethylamides of formula (I) according to the present invention are N,N-dimethylamides, in particular N,N-dimethyl heptanamide; N,N-dimethyloctanamide; N,N-dimethylnonanamide; N,N-dimethyldecanamide; N,N-dimethylundecanamide; N,N-dimethyldodecanamide; N,N-dimethyltridecanamide; N,N-dimethylethylhexanamide, for instance N,N-dimethyl-2-ethylhexanamide or N,N-dimethyl-3 ethyl hexanamide; N, N-dimethyl methylhexanamide, for instance N, N-dimethyl-2-methyl hexanamide or N, N-dimethyl-3-methyl hexanamide; N, N-dimethyl methyl pentamide, for instance N, N-dimethyl-2-methyl pentamide or N, N-dimethyl-3-methyl pentamide; or N, N-dimethyl-dimethyl nonanamide, for instance N, N-dimethyl-4,8-dimethyl nonanamide. Particularly preferred are N, N-dimethyloctanamide, N, N-dimethyldecanamide and N, N-dimethyldodecanamide.

Specific examples of suitable mixtures of N,N-dimethylamides include mixtures of N,N-dimethyloctanamide N,N-dimethyldecanamide or mixtures of N,N-dimethyloctanamide, N,N-dimethylnonanamide and N,N-dimethyldecanamide. These could be prepared starting from C₈-C₁₀ fatty acids, which may be regarded as short-chain fatty acids, with dimethyl amine.

Particularly preferred is N, N-dimethyloctanamide; N, N-dimethyldecanamide and mixtures thereof.

Preferred are dimethylamides prepared by converting naturally occurring acids such as octanoic acid, decanoic acid and undecanoic acid i.e. with saturated aliphatic groups or oleic acid as an example of unsaturated aliphatic group. These compounds can be converted to the corresponding dimethylamides by the reaction of the aforesaid corresponding acids with dimethylamine.

The amount of dimethyl amide of formula (I) may be generally from 0.1 phr to 15 phr, typically from 0.1 phr to 10 phr, suitably from 1 phr to 5 phr, and preferably from 2 phr to 3 phr.

Desirably, the elastomeric composition further comprises (d) at least one polyalkylene glycol. The polyalkylene glycol may be any polyalkylene glycol. Suitably the polyalkylene glycol may be either polyethylene glycol or polypropylene glycol or a mixture of polyethylene glycol and polypropylene glycol (referred to as PEO/PPO) or a polyalkylene glycol containing a mixture of ethylene oxide repeating units and propylene oxide repeating units (referred to as P-EO-PO). More desirably, the polyalkylene glycol is polyethylene glycol or P-EO-PO. Suitably, the P-EO-PO would have a ratio of >0:<100 to <100: >0 ethylene oxide units to propylene oxide units, for instance 1:99 to 99:1. More preferably the polyalkylene glycol is polyethylene glycol.

Preferably the polyalkylene glycol (d), more preferably polyethylene glycol (d), is of medium molecular weight. By medium molecular weight we mean that the polyalkylene glycol, preferably polyethylene glycol, would have a weight average molecular weight from 400 to 8000, suitably from 1500 to 8000, desirably from 1500 to 6000.

The use of at least one polyalkylene glycol, preferably polyethylene glycol, and at least one N,N-dimethyl amide of formula (I), in the elastomeric material, for instance for tread band according to the present invention produces a further improving effect. In fact, both the processability of the elastomeric material and the rolling resistance and, more generally, the characteristics already improved by the use of the N,N-dimethyl amide are higher than the results obtained by using the N, N-dimethylamide of formula (I) alone. The elastomeric material comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula (I) according to the present invention can be advantageously used also for the preparation of tread bands useful for the reconstruction of tyres, the so-called retreated tyres.

Generally, the amount of reinforcing filler contained in the elastomeric material, e.g. when included in the tyre, according to the present invention does not represent a critical parameter but more evident results in terms of improved workability of the elastomeric material are obtained with an amount of reinforcing filler lower or equal to 100 phr, preferably from 10 phr to 100 phr, more preferably from 15 phr to 70 phr. Among the specific examples of reinforcing fillers that can be used in the present invention silica, alumina, silicates, hydrotalcite, calcium carbonate, kaolin, titanium dioxide and mixtures thereof can be cited.

Among the specific examples of silica, pyrogenic silica, amorphous precipitated silica, wet silica (hydrated silicic acid), fumed silica or mixtures thereof can be particularly cited.

Silica is preferably used, more preferably amorphous precipitated silica with a surface area as described in Standard ISO 5794-1:2005 from 1 m²/g to 200 m²/g, preferably from 10 m²/g to 150 m²/g, more preferably from 20 m²/g to 110 m²/g.

The amount of elastomeric material of the present invention that may be included in a tyre preferably comprises from 15 phr to 70 phr of a silica reinforcing filler. Examples of silica reinforcing fillers that can be used according to the present invention are commercially available products under the trademarks Hi-Sil® 190, Hi-Sil® 210, Hi-Sil® 215, Hi-Sil® 233, Hi-Sil® 243 from PPG Industries; Ultrasil® VN2, Ultrasil® VN3, Ultrasil® 7000 from Degussa; Zeosil® 1 165MP from Rhodia.

Specific examples of silicates are phyllosilicates, such as for example, montmorillonite, bentonite, nontronite, beidellite, volkonskoite, hectorite, saponite, sauconite, vermiculite, halloysite, sericite or mixtures thereof. Montmorillonite is particularly preferred. These layered materials generally contain exchangeable ions such as sodium (Na⁺), calcium (Ca²⁺), potassium (K⁺), magnesium (Mg²⁺), hydroxide (OH⁻) or carbonate (CO₃²⁻) onto the surfaces between the layers.

The polymeric component of the elastomeric material, according to the present invention, can be formed of any elastomeric polymer or elastomeric polymer mixture and desirably those commonly used for the production of tyres and particularly for the production of treads.

The elastomeric polymer (a) may be a natural elastomeric polymer or a synthetic elastomeric polymer or mixtures thereof. Suitably the elastomeric polymer (a) may be a diene polymer that can be selected from those commonly used in sulphur cross-linkable elastomeric materials, that are particularly suitable for producing tyres. Such sulphur cross linking may be referred to as vulcanisation.

Elastomeric polymers may be C—C double bonds and such C—C double bonds may be vinyl groups, —CH═CH₂, or —C—(CH₃)═CH₂) groups or internal double bonds such as —CH═C(CH₃)— groups. Both vinyl groups and C—C-double bonds allow for cross-linking the polymer chains of the elastomeric material, e.g. by vulcanisation.

Examples of elastomeric polymers (a) include polybutadiene, polychloroprene, also called neoprene, acrylonitrile butadiene rubber (NBR), ethylene propylene diene monomer rubber (EPDM), natural rubber, poly-2,3-dimethyl butadiene, styrene butadiene rubber (SBR), butyl rubber, carboxylated nitrile rubber (XNBR), hydrogenated carboxylated nitrile rubber (HXNBR), and mixtures of at least 2 of the foregoing. One suitable elastomeric polymer (a) is SBR. Suitable binary mixtures are co-vulcanisates of SBR and neoprene and of SBR and natural rubber, and of SBR and butyl rubber. SBR may be made in solution (S-SBR) or in emulsion (E-SBR).

Desirably, the elastomeric polymers may be homopolymers or copolymers with an unsaturated chain having a glass transition temperature (Tg) generally below 20° C., preferably in the range of from 0° C. to −110° C. These homopolymers or copolymers can be of natural origin or can be obtained by polymerisation in solution, polymerisation in emulsion or gas phase polymerisation of one or more conjugated by olefins, optionally blended with at least one comonomer selected from mono vinyl arenes and/or polar comonomers in an amount not higher than 60% by weight.

The conjugated diolefins generally contain from 4 to 12, preferably from 4 to 8 carbon atoms and can be selected, for instance, from 1,3-butadiene, isoprene, 2-3-dimethyl-1,3-butadiene, 1,3-pentadiene, 1,3-hexadiene, 3-butyl-1,3-octadiene, 2-phenyl-1,3-butadiene or mixtures thereof. 1,3-butadiene and isoprene are more preferred.

Monovinylarenes, which can optionally be used as comonomers, in general contain from 8 to 20, preferably from 8 to 12 carbon atoms and can be selected, for example, from styrene; 1-vinyl naphthalene; 2-vinyl naphthalene; various alkyl, cycloalkyl, aryl, alkyl aryl or aryl alkyl derivatives of styrene, such as, for example, α-methyl styrene, 3-methyl styrene, 4-propyl styrene, 4-cyclohexyl styrene, 4-dodecyl styrene, 2-ethyl-4 benzyl styrene, 4-p-tolyl styrene, 4-(4-phenyl butyl) styrene, or mixtures thereof. Styrene is especially preferred.

Polar comonomers, which can be optionally used, can be selected from, for example, vinylpyrrolidine, vinyl quinoline, acrylic acid and alkyl acrylic acid esters and nitriles or mixtures thereof, such as, for example, methyl acrylate, ethyl acrylate, methyl methacrylate, ethyl methacrylate, acrylonitrile or mixtures thereof.

Preferably the elastomeric polymer (a) is a diene polymer. This elastomeric diene polymer suitable for the present invention can be selected, for example, from cis-1,4-poly-isoprene (natural or synthetic, preferably natural rubber), 3,4 polyisoprene, polybutadiene (in particular polybutadiene with a high 1,4-cis content), optionally halogenated isoprene/isobutylene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers or mixtures thereof.

According to one preferred embodiment, said elastomeric material comprises at least 10% by weight of natural rubber, preferably from 20% by weight to 100% by weight of natural rubber, with respect to the total weight of said at least one elastomeric diene polymer (a).

The above-mentioned elastomeric material can optionally comprise at least one elastomeric polymer of one or more monoolefins with an olefinic comonomer or derivatives thereof (a′). The monoolefins can be selected from ethylene and an α-olefin, optionally with a diene; isobutylene homopolymers or copolymers thereof with small amount of a diene, which are optionally at least partially halogenated. The optionally present diene generally contains from 4 to 20 carbon atoms and is preferably selected from 1,3-butadiene, isoprene, 1,4-hexadiene, 1,4-cyclo hexadiene, 5-ethyldiene-2-norbornene, 5-methylene-2-norbornene, vinyl norbornene or mixtures thereof. Among fees, the following are particularly suitable: ethylene/propylene copolymers (EPR) or ethylene/propylene/diene copolymers (EPDM); polyisobutylene; butyl rubbers; halobutyl rubbers, in particular chlorobutyl or bromobutyl rubbers, or mixtures thereof.

An elastomeric diene polymer (a) or an elastomeric mono olefin polymer (a′) functionalized by reaction with suitable terminating or coupling agents can be optionally used. In particular, the elastomeric diene polymers obtained by anionic polymerization in the presence of an organometallic initiator (particularly an organolithium initiator) can be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes. Optionally, said elastomeric material can also include at least one carbon black reinforcing filler (e).

The additional reinforcing filler can be selected among those used for crosslinked products, particularly carbon black or its aggregates with silica derivatives as described for example in U.S. Pat. No. 6,057,387.

According to a preferred embodiment, the carbon black reinforcing filler (e) that can be used in the present invention can be selected among those having a surface area not less than 20 m²/g (determined by STSA—statistical thickness surface area according to ISO 18852:2005).

According to a preferred embodiment, said carbon black reinforcing filler (e) is present in the elastomeric material in an amount from 0.1 phr to 120 phr, preferably from 3 phr to 90 phr. The elastomeric material can also include at least one silane coupling agent (f).

According to a preferred embodiment, the silane coupling agent (f) that can be used in the present invention can be selected among those having at least a hydrolysable silane group that can be identified, for example, by the following general formula (II):

(R′)₃Si—CₙH₂ₙ—X (II)

wherein the groups R′, the same or different from each other, are selected among: alkyl, alkoxy or aryloxy groups or among halogen atoms, provided that at least one of the R′ groups is an alkoxy or aryloxy group; n is an integer from 1 to 6, extremes included; X is a group selected among: nitroso, mercapto, amino, epoxide, vinyl, imide, chloro, —(S)ₘCₙH₂ₙ—Si—(R′)₃ or —S—COR′, wherein m and n are integers from 1 to 6, extremes included and the R′ groups are as defined above.

Among the silane coupling agents, those particularly preferred are bis(3-triethoxysilylpropyl)tetrasulphide and bis(3-triethoxysilylpropyl)disulphide. Said coupling agents can be used as such or as a suitable mixture with an inert filler (for example carbon black) as to facilitate their incorporation into the elastomeric material.

According to a preferred embodiment, said silane coupling agent (f) is present in the elastomeric material in an amount from 0.01 phr to 10 phr, preferably from 0.5 phr to 5 phr.

The abovementioned elastomeric materials can be vulcanised according to known techniques, in particular with sulphur vulcanising systems commonly used for elastomeric diene polymers. For this purpose, after one or more steps of thermo-mechanical treatment, a sulphur vulcanising agent is incorporated into the material together with vulcanisation accelerators. In the final treatment step, the temperature is generally kept below 120° C. and preferably below 100° C., so as to avoid any unwanted pre-crosslinking phenomena.

The vulcanising agent more advantageously used is sulphur or molecules comprising sulphur (sulphur donors), with accelerators and activators known to those skilled in the art.

The activators that are particularly effective are zinc compounds and particularly ZnO, ZnCO₃, zinc salts of saturated or unsaturated fatty acids containing from 8 to 18 carbon atoms, such as, for example, zinc stearate, which are preferably formed in situ in the elastomeric material from ZnO and fatty acid, as well as BiO, PbO, Pb₃O₄, PbO₂ or mixtures thereof.

Accelerators that are commonly used can be selected among: dithiocarbamates, guanidine, thiourea, thiazoles, sulphenamides, thiurams, amines, xanthates or mixtures thereof.

Said elastomeric materials can include other commonly used additives selected on the basis of the specific application for which the material is intended. For example, antioxidants, anti-ageing agents, plasticizers, adhesives, anti-ozone agents, modifying resins, fibres (for example Kevlar® pulp) or mixtures thereof can be added to said materials.

Particularly, for the purpose of further improving the processability, a plasticizer, generally selected among mineral oils, vegetable oils, synthetic oils or mixtures thereof, such as for example, aromatic oil, naphtenic oil, phthalates, soybean oil or mixtures thereof, can be added to said elastomeric material. The amount of plasticizer is generally from 0 phr to 70 phr, preferably from 5 phr to 30 phr.

The abovementioned elastomeric materials can be prepared by mixing together the polymeric components with the reinforcing filler and with the other additives optionally present according to techniques known in the art. The mixing can be carried out, for example, by using an open mixer of open-mill type or an internal mixer of the type with tangential rotors (Banbury) or with interlocking rotors (Intermix) or in continuous mixers of Ko-Kneader (Buss) or of co-rotating or counter- rotating twin-screw type.

As used herein, the term “phr” (acronym of parts per 100 parts of rubber) means the parts by weight of a given component of elastomeric material per 100 parts by weight of the elastomeric polymer.

As used herein, all ranges include any combination of the reported maximum and minimum points and include any intermediate ranges therein which can or cannot be specifically enumerated in the present description.

The invention may be defined by the following embodiments.

Embodiment 1. Use of at least one N,N-dimethylamide as an additive in an elastomeric composition for producing a tread band for vehicle wheels, wherein the at least one N,N-dimethylamide has the formula:

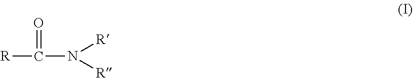

wherein:
R is a C₆-C₁₂ alkyl group, and
R′ and R″ are methyl.

Embodiment 2: Use according to embodiment wherein the elastomeric composition is vulcanised to form an elastomeric material by vulcanising the elastomeric composition which elastomeric composition comprises (a) at least one elastomeric polymer, (b) at least one reinforcing filler selected from hydroxides, oxides and hydrated oxide, salts and hydrated salts of metals or mixtures thereof and (c) the at least one N,N-dimethylamide.

Embodiment 3: Use according to embodiment 1 or embodiment 2 wherein the elastomeric composition further comprises (d) at least one polyalkylene glycol, preferably polyethylene glycol or P-EO-PO, more preferably polyethylene glycol.

Embodiment 4: Use according to any preceding embodiment wherein the elastomeric composition comprises a N,N-dimethylamide of formula (I), wherein R is a C₇-C₁₁ alkyl group.

Embodiment 5: Use according to any of embodiments 2 to 4 wherein said elastomeric material is formed by vulcanising an elastomeric composition comprising a N,N-dimethylamide of formula (I) in an amount from 0.1 phr to 15 phr, preferably 0.1 phr to 10 phr.

Embodiment 6: Use according to any of embodiments 2 to 5 wherein said elastomeric material is formed by vulcanising an elastomeric composition comprising a N,N-dimethylamide of formula (I) in an amount from 1 phr to 5 phr.

Embodiment 7: Use according to any of embodiments 2 to 6 and wherein said elastomeric material is formed by vulcanising an elastomeric composition comprising a N,N-dimethylamide of formula (I) in an amount from 2 phr to 3 phr.

Embodiment 8: Use according to any of embodiments 3 to 7 wherein said polyalkylene glycol, preferably polyethylene glycol, is a medium molecular weight polyalkylene glycol, preferably polyethylene glycol.

Embodiment 9: Use according to any one of embodiments 2 to 8 wherein said polyalkylene glycol, preferably polyethylene glycol, has a weight average molecular weight from 1500 to 8000.

Embodiment 10: Use according to any of embodiments 2 to 9 wherein said reinforcing filler is included in an amount lower or equal to 100 phr.

Embodiment 11: Use according to any of embodiments 2 to 10 wherein said reinforcing filler is in an amount from 10 phr to 100 phr.

Embodiment 12: Use according to any of embodiments 2 to 11 wherein said reinforcing filler is in an amount from 15 phr to 70 phr.

Embodiment 13: Use according to any of embodiments 2 to 12 wherein said reinforcing filler (b) is silica.

Embodiment 14: Use according to any of embodiments 2 to 13 wherein said elastomeric composition further comprises (e) at least one reinforcing filler of carbon black.

Embodiment 15: Use according to any embodiments 2 to 14 wherein said elastomeric material further comprises (f) at least one silane coupling agent.

Embodiment 16: A vulcanised elastomeric material for producing a tread band for vehicle wheels obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula:

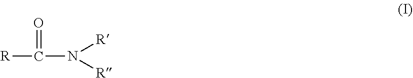

wherein:
R is a C₆-C₁₂ alkyl group,
R′ and R″ are methyl.

Embodiment 17: The vulcanised elastomeric material of embodiment 16 comprising any of the features defined in any of embodiments 2 to 15.

Embodiment 18: A tread band for vehicle wheels comprising a vulcanised elastomeric material, which vulcanised elastomeric material is obtained by vulcanising an elastomeric composition comprising (a) at least one elastomeric polymer, (b) at least one reinforcing filler selected among hydroxides, oxides and hydrated oxides, salts and hydrated salts of metals or mixtures thereof and (c) at least one N,N-dimethylamide of formula:

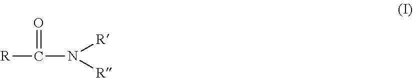

wherein:
R is a C₆-C₁₂ alkyl group,
R′ and R″ are methyl.

Embodiment 19: The tread band of embodiment 18 comprising any of the features defined in any of embodiments 2 to 16.

The present description will be further illustrated by some examples which are given for purely indicative purposes and without any limitation to this invention.

### Description of Vulcanisation

Elastomeric materials may be prepared in the following way (the amounts of the various components are indicated in phr).

All the components, except sulphur and accelerator, were mixed in an internal mixer (model Pomini PL 1.6) for about 5 minutes (1^{st} phase). When the temperature reached 145° C.±7° C., the elastomeric material was discharged. Sulphur and accelerator were added, and the mixing was carried out in an open roll mixer (2^{nd} phase).

### EXAMPLES

Rubber formulations were prepared using the test recipe shown in Table 1 below. The process involved forming a mixture of unsaturated organic elastomers; carbon black and silica as reinforcing fillers; coupling agents; dispersants; plasticisers; sulphur as a cross-linker (vulcanising agent); zinc-based catalyst and accelerators. Vulcanisation starts ahead of 100° C. and achieved by heating and needing of the mixture. Vulcanisation was continued at 151° C. for 30 minutes. At the end of vulcanisation, the mixture is formed into final desired parts, for example rubber sheets by a roller press.

TABLE 1
First Series - PHR-Recipe

| Compo- | | | | |
|---|---|---|---|---|
| nent | Component | | Amount | Parts |
| Pos. No. | Name | Type | (phr) | (wt. %) |
| 01 | SIR20 | natural rubber | 100 | 58 |
| 02 | Ultrasil ® | reinforcing silica | 44 | 25 |
| | 7000GR | | | |
| 03 | N550 | carbon black | 6.5 | 3.7 |
| 04 | Si-69 | silane coupling | 3.5 | 2 |
| | | agent | | |
| 05 | N550 | carbon black | 3.5 | 2 |
| 06 | ADDITIVE | | 2 | |
| 07 | Pioneer ® M1930 | | 1 | 0.6 |
| 08 | stearic acid | dispersant | 2 | 1.2 |
| 09 | Avozinc ® 80 | zinc oxide | 3.6 | 2.1 |
| 10 | ASM 6 PPd | | 1.9 | 1.1 |
| 11 | Premix TBBS 80 | | 2.3 | 1.3 |
| 12 | Premix PTC 80 | | 0.1 | 0.06 |
| 13 | Sulfur 90/95 | sulfur | 2.6 | 1.5 |

ADDITIVE

| | |
|---|---|
| ADDITIVE 0 | Blank - no additive |
| ADDITIVE 1 | N,N-dimethylamide, where R = C₇-C₉ |
| ADDITIVE 2 | N,N-dimethylamide, where R = C₉ |
| ADDITIVE 3 | N,N-dimethylamide, where R = C₁₁ |

Mooney ME viscosity (1+4) at 100° C. was measured according to Standard DIN 53523

Test pieces were taken by cutting 3 pieces each in 0° and 90° angles of finished vulcanized test sheet rubber mat material, test equipment readings intermediate values reported below

The following parameters were measured in accordance with the stated standards.
Density g/ccm DIN EN ISO 1183 at RT
Shore A Hardness DIN ISO 7619
Rebound Elasticity % DIN 53512 at RT
Vulcameter curve Texas Instruments

DMTA measurements ISO 6721-7; 1 Hz; −100° C.-+100° C. for Storage Module G′, Loss Module G″ and tan delta

### Results

The results of the measured parameters are presented in Table 2 below.

TABLE 2
Results

| Example | 0 | 1 | 2 | 3 |
|---|---|---|---|---|
| Mooney ME visco (1 + 4) | 91 | 75 | 73 | 70 |
| Elongation at break (%) | 612 | 608 | 602 | 580 |
| Hardness ShoreA | 64 | 63 | 62 | 60 |
| Rebound Elasticity (%) | 57 | 56 | 54 | 55 |
| E-Module (MPa) | 3.6 | 3.3 | 3.3 | 3.2 |
| Toughness (J/cm3) | 11 | 6.9 | 6.8 | 6.4 |
| Dynamics DMTA | | | | |
| −20° C. | | | | |
| G′ (E + 7 MPa) | 8 | 7.5 | 7.5 | 7 |
| G″ (E + 6 MPa) | 7 | 5 | 5 | 5 |
| Tan delta | 0.30 | 0.32 | 0.32 | 0.34 |
| 25° C. | | | | |
| G′ (E + 7 MPa) | 2 | 1.2 | 1.1 | 1.0 |
| G″ (E + 6 MPa) | 3 | 1.5 | 1.5 | 1.5 |
| Tan delta | 0.28 | 0.33 | 0.34 | 0.36 |
| 70° C. | | | | |
| G′ (E + 7 MPa) | 1 | 0.8 | 0.75 | 0.76 |
| G″ (E + 6 MPa) | 1 | 0.5 | 0.5 | 0.5 |
| Tan delta | 0.8 | 0.78 | 0.76 | 0.73 |

Materials including FADMA show a significant decrease in Mooney Viscosity which means the material would exhibit improved processing with respect to blank material.

Modulus and hardness/stiffness (E′) and elasticity of vulcanized goods stay close to blank values

Reduction of tan delta at 70° C. without extreme reduction of dynamic module G′ at same temperature may indicate a material of lower rolling resistance at same stiffness of material.

Reduction of E′ module at about 0° C. (range −20° C.-+25° C.) means a composition with better performance on wet surfaces.

REM SEM microscopy and EDX showed that the SiO₂-filler, Sulfur-crosslinker and ZnO-catalyst exhibited and even distribution throughout the matrix of the elastomeric material.

In a further series of tests elastomeric materials based on a carbon black rich formulation were evaluated. The recipe is illustrated in Table 3.

TABLE 3
2^{nd} Series PHR-Recipe

| Pos. | Name | Type | Amount (phr) |
|---|---|---|---|
| 01 | NR | natural rubber | 85 |
| 02 | BR | polybutadiene | 15 |
| 03 | N550 | carbon black | 45 |
| 04 | Si69 | silane | 3 |
| 05 | Ultrasil ® 7000Gr | silica | 15 |
| 06 | ADDITIVE | | 3 |
| 07 | Stacid ® | stearic acid | 1 |
| 08 | Vulcanox ® HS | TMQ | 1 |
| 09 | Santoflex ® 13 | 6-PPD | 2 |
| 10 | Vulcacit ® CBS | sulphenamide | 1 |
| 11 | Vulcalent ® G | thiophtalamide | 0.3 |
| 12 | Sulfur 90/95 | sulfur | 2 |

| | |
|---|---|
| ADDITIVE 0 = Tudalen ® 1849 | (aromatic oil diluent) |
| ADDITIVE 1 | N,N-dimethylamide, |
| | where R = C₂ |
| ADDITIVE 2 | N,N-dimethylamide, |
| | where R = C₇-C₉ |
| ADDITIVE 3 | N,N-dimethylamide, |
| | where R = C₁₁ |
| ADDITIVE 4 = Vulcanol ® TOF | tri-ethylhexyl- |
| | phoshate (Lanxess) |
| ADDITIVE 5 = Surfadone ® LP100 | N-octylpyrrolidone (Ashland) |
| ADDITIVE 6 = Pluriol ® E6000 | PEO (BASF) |
| ADDITIVE 7 = Pluriol ® E6000 + | (1.5 phr each) |
| N,N-dimethylamide, where R = C₇-C₉ | |
| ADDITIVE 8 = Pluriol E6000 + | (1.5 phr each) |
| Surfadone ® LP100 | |
| Blank 9 = no addition | |

The elastomeric materials were prepared analogously to the procedure given above in regard to the first series of tests and parameters tested similarly to the standards stated above regarding the first series.

### Results

The results are presented in Table 4.

TABLE 4

| | | Relative | | Relative | | Relative |
|---|---|---|---|---|---|---|
| | Mooney | reduction | Tan delta | Increase | Tan delta | Reduction |
| No | Viscosity | (%) | @ 0° C. | (%) | @ 60° C. | (%) |
| 0 | 167 | 7 | 0.2828 | 1 | 0.1520 | −1 |
| 1 | 157 | 13 | 0.2965 | 6 | 0.1455 | 3 |
| 2 | 144 | 20 | 0.3048 | 9 | 0.1410 | 6 |
| 3 | 142 | 21 | 0.3070 | 10 | 0.1420 | 6 |
| 4 | 158 | 11 | 0.3023 | 8 | 0.1471 | 2 |
| 5 | 144 | 20 | 0.3052 | 9 | 0.1394 | 7 |
| 6 | 165 | 8 | 0.2995 | 7 | 0.1474 | 2 |
| 7 | 136 | 27 | 0.3960 | 11 | 0.1426 | 5 |
| 8 | 139 | 23 | 0.3960 | 9 | 0.1427 | 5 |
| 9 | 180 | | 0.2804 | | 0.1503 | |

The physical properties measured for the elastomeric materials prepared using the inventive dimethyl amides of the present invention (especially where R is C7-C11) come close to one market standard N-octyl pyrrolidone.

The performance of the elastomeric material prepared using the inventive dimethyl amide of the present invention is better than another market standard, Vulcanol® TOF.

The reduction in the Mooney viscosity on the pre-vulcanised material is an indication of better handling and easier mixing and processability in general.

An increase in Tan delta 0° C. is an indication of improved wet grip of the elastomeric material, e.g. a tyre, under colder conditions i.e. 0° C.

A decrease of tan delta 60° C. is an indication of reduced rolling resistance of the elastomeric material, i.e. a tyre, at elevated temperatures. This is important indication of improved performance and reduced wear as a road tyre heats up during usage.

A combination of the inventive dimethyl amide with polyethylene oxide (PEO) illustrates 8 slightly better performance which is an indication of a synergistic effect.

1.-15. (canceled)

16. A vulcanised elastomeric material for producing a tread band for vehicle wheels obtained by vulcanising an elastomeric composition comprising (a) at least one elastomeric polymer, (b) at least one reinforcing filler selected from the group consisting of hydroxides, oxides, hydrated oxides, salts, hydrated salts of metals or mixtures thereof, and (c) at least one N,N-dimethylamide of formula: 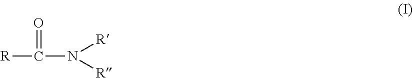
wherein:
R is a C₆-C₁₂ alkyl group,
R′ and R″ are methyl.

17. (canceled)

18. A tread band for vehicle wheels comprising a vulcanised elastomeric material, which vulcanised elastomeric material is obtained by vulcanising an elastomeric composition comprising (a) at least one elastomeric polymer, (b) at least one reinforcing filler selected from the group consisting of hydroxides, oxides, hydrated oxides, salts, hydrated salts of metals or mixtures thereof, and (c) at least one N,N-dimethylamide of formula: 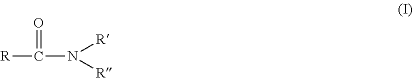
wherein:
R is a C₆-C₁₂ alkyl group,
R′ and R″ are methyl.

19. (canceled)

20. The vulcanized elastomeric material according to claim 16 wherein the elastomeric composition is vulcanised to form an elastomeric material by vulcanising an elastomeric composition which elastomeric composition comprises (a) at least one elastomeric polymer, (b) at least one reinforcing filler selected from hydroxides, oxides, hydrated oxides, salts, and hydrated salts of metals or mixtures thereof, and (c) the at least one N,N-dimethylamide of formula (I).

21. The vulcanized elastomeric material according to claim 16 wherein the elastomeric composition further comprises (d) at least one polyalkylene glycol.

22. The vulcanized elastomeric material according to claim 16 wherein the elastomeric composition comprises the N,N-dimethylamide of formula (I), wherein R is a C₇-C₁₁ alkyl group.

23. The vulcanized elastomeric material according to claim 16 wherein said elastomeric material is formed by vulcanising an elastomeric composition comprising a N,N-dimethylamide of formula (I) in an amount from 0.1 phr to 15 phr.

24. The vulcanized elastomeric material according to claim 20 wherein said elastomeric material is formed by vulcanising an elastomeric composition comprising a N,N-dimethylamide of formula (I) in an amount from 1 phr to 5 phr.

25. The vulcanized elastomeric material according to claim 20 wherein said elastomeric material is formed by vulcanising an elastomeric composition comprising a N,N-dimethylamide of formula (I) in an amount from 2 phr to 3 phr.

26. The vulcanized elastomeric material according to claim 21 wherein said polyalkylene glycol is a medium molecular weight polyalkylene glycol.

27. The vulcanized elastomeric material according to 26 wherein said polyalkylene glycol has a weight average molecular weight from 1500 to 8000.

28. The vulcanized elastomeric material according to claim 20 wherein said reinforcing filler is included in an amount lower or equal to 100 phr.

29. The vulcanized elastomeric material according to claim 28 wherein said reinforcing filler is included in an amount from 10 phr to 100 phr.

30. The vulcanized elastomeric material according to claim 29 wherein said reinforcing filler is included in an amount from 15 phr to 70 phr.

31. The vulcanized elastomeric material according to claim 20 wherein said reinforcing filler (b) is silica.

32. The vulcanized elastomeric material according to claim 20 wherein said elastomeric composition further comprises (e) at least one reinforcing filler of carbon black.

33. The vulcanized elastomeric material according to claim 20 wherein said elastomeric material further comprises (f) at least one silane coupling agent.

34. The vulcanized elastomeric material according to claim 21 wherein the polyalkylene glycol comprises polyethylene glycol or PO-EP-PO.

35. The vulcanized elastomeric material according to claim 34 wherein the polyalkylene glycol comprises polyethylene glycol.
